(19) United States
(12) Patent Application Publication
(10) Pub. No.: US 2017/0225302 A1
(43) Pub. Date: Aug. 10, 2017

(54) RATCHET WRENCH

(71) Applicant: Compass Corp., Tainan City (TW)

(72) Inventor: Tzu-Chien Wang, Tainan City (TW)

(21) Appl. No.: 15/040,768

(22) Filed: Feb. 10, 2016

(51) Int. Cl. B25B 13/46

(52) U.S. Cl. CPC B25B 13/463

(57) ABSTRACT

A ratchet wrench includes a ratchet wheel made of metal and having a ratchet teeth section and a driving section. A pawl made of metal engages with the ratchet teeth section and is controlled by a switch to control the rotation direction of the ratchet wheel. A plate made of metal includes a coupling portion to which the ratchet wheel is coupled. The coupling portion includes a first through-hole through which the ratchet wheel extends. The pawl presses against an inner periphery of the first through-hole. The inner periphery of the first through-hole has a length in an axial direction smaller than a thickness of the ratchet teeth section. A stopper made of plastic material is mounted around a peripheral edge of the coupling portion and includes second and third through-holes respectively located corresponding to the driving section of the ratchet wheel and the switch of the direction changing unit.

### BACKGROUND OF THE INVENTION

The present invention relates to a ratchet wrench and, more particularly, to a ratchet wrench having a reduced weight, permitting easy manufacture, and having better applications.

The driving direction of ratchet wrenches can be changed to permit convenient operation while driving a fastener or the like. FIG. 10 shows a conventional ratchet wrench including a handle 1′, a ratchet wheel 2′, a direction changing device 3′, and a cover plate 4′. The handle 1′ is made of metal and includes a head 11′ in the form of a sleeve on an end thereof. The head 11′ includes a compartment 12′ having an opening 13′. The ratchet wheel 2′ is made of metal and includes a ratchet teeth section 21′ and a driving section 22′. The ratchet teeth section 21′ is received in the compartment 12′ of the head 11′ and can rotate relative to the head 11′. The direction changing device 3′ includes two metal pawls 31′, two springs 32′, a pressing block 33′, and a switch 34′. The pawls 31′, the springs 32′, and the pressing member 33′ are mounted in the compartment 12′. An end of each pawl 31′ presses against an inner wall of the compartment 12′. The switch 34′ is mounted outside of the head 11′. The cover plate 4′ is made of metal and is mounted in the opening 13′ of the compartment 12′ to prevent the components in the compartment 12′ from falling off.

The switch 34′ can be manually operated to press against one of the pawls 33′ for engaging an end of the pawl 33′ with an outer periphery of the ratchet teeth section 21′, such that the ratchet wheel 2′ can rotate relative to the head 11′ in a direction. When the ratchet wheel 2′ moves in a reverse direction, two ends of each pawl 31′ respectively press against the inner wall of the compartment 12′ and the ratchet teeth section 21′ to provide a torque for driving a fastener or the like.

However, all of the components of the above ratchet wrench are made of metal, and the overall weight of the ratchet wrench is heavy. Furthermore, the weight at the end of the ratchet wrench having the ratchet wheel 2′ is heavier than the other end of the ratchet wrench, leading to inconvenient operation due to the uneven weight. Furthermore, the user will feel discomfort resulting from cold feeling of the metal material of all of the components of the ratchet wrench.

To avoid the above disadvantages, Taiwan Utility Model M478571 discloses a ratchet wrench including a first body made of a lighter material. A compartment is defined in an end of the first body for receiving a second body with a better strength. A handle is provided on the other end of the first body 10. The second body receives a ratchet wheel device. Although the above structure can reduce the weight, the strength at the handle of the first body is not good, such that the first body is apt to deform when subjected to a larger rotational torque. Furthermore, the torque is transmitted from the ratchet wheel device through the second body to the first body having a smaller strength, leading to deformation of the compartment. Furthermore, the second body causes an increase in the manufacturing costs.

Taiwan Utility Model M453559 discloses a ratchet wrench having a metal body. The body includes a driving head and a handle. The driving head is in the form of a sleeve for receiving a ratchet wheel device. The body is enveloped by plastic enveloping members to provide comfort gripping. However, the enveloping members increase the weight and the manufacturing costs.

### BRIEF SUMMARY OF THE INVENTION

An objective of the present invention is to provide ratchet wrench having a reduced weight, permitting easy manufacture, and having better applications.

A ratchet wrench according to the present invention includes a ratchet wheel device, a plate, and a stopper. The ratchet wheel device includes a ratchet wheel and a direction changing unit. The ratchet wheel is made of metal and includes a ratchet teeth section and a driving section. The direction changing unit includes a pawl made of metal and engaged with the ratchet teeth section of the ratchet wheel. The direction changing unit further includes a switch operable to control movement of the pawl to thereby permit the ratchet wheel to rotate in a single direction. The plate is made of metal and includes a first end having a coupling portion. The ratchet wheel device is coupled to the coupling portion. The plate further includes a second end having a handle portion. The coupling portion includes a first through-hole through which the ratchet wheel device extends. The pawl presses against an inner periphery of the first through-hole. The inner periphery of the first through-hole has a length in an axial direction smaller than a thickness of the ratchet teeth section in the axial direction. The stopper is made of plastic material and is mounted around a peripheral edge of the coupling portion of the plate. The stopper includes second and third through-holes respectively located corresponding to the driving section of the ratchet wheel device and the switch of the direction changing unit. The stopper prevents the ratchet wheel device from disengaging from the plate while permitting rotation of the ratchet wheel relative to the plate.

The ratchet wheel device can further include a first abutment edge and a second abutment edge spaced from the first abutment edge in the axial direction. The stopper can further include a first stop edge abutting the first abutment edge and a second stop edge abutting the second abutment edge, preventing the ratchet wheel device from disengaging from the plate.

In an example, after the ratchet wheel device is mounted to the coupling portion of the plate, the stopper is formed on the coupling portion of the plate by injection molding and envelops and engages with the coupling portion of the plate.

In another example, the stopper includes first and second covers. The first stop edge is provided on the first cover, and the second stop edge is provided on the second cover. The first cover and the second cover envelop the coupling portion of the plate. A peripheral edge of the first cover is coupled with a peripheral edge of the second cover.

The stopper can also envelop the handle portion of the plate. The plate can have a uniform thickness. The plate can include an operative end. The operative end can be a fastener driving hole, a bottle opener, or a can opener.

The direction changing unit of the ratchet wheel device can further include a spring to which the switch is operatively coupled to. The spring has an end pressing against the pawl. The switch can be operated to make the spring press against the pawl to thereby move the pawl to different angular positions relative to the ratchet teeth section, controlling the ratchet wheel to rotate relative to the plate in only one direction.

The direction changing unit can further include a stop ring and a retaining ring. The stop ring abuts a side of the direction changing unit. The retaining ring is coupled to the ratchet wheel and abuts the stop ring. The retaining ring includes a side forming the second abutment edge. The first abutment edge is provided on a side of the ratchet wheel opposite to the retaining ring.

The present invention will become clearer in light of the following detailed description of illustrative embodiments of this invention described in connection with the drawings.

### DESCRIPTION OF THE DRAWINGS

FIG. 1 is an exploded, perspective view of a ratchet wrench of a first embodiment according to the present invention.

FIG. 2 is a perspective view of the ratchet wrench of FIG. 1 after assembly.

FIG. 3 is a cross sectional view taken along section line A-A of FIG. 2.

FIG. 4 is a cross sectional view taken along section line B-B of FIG. 2.

FIG. 5 is a cross sectional view taken along section line C-C of FIG. 2.

FIG. 6 is an exploded, perspective view of a ratchet wrench of a second embodiment according to the present invention.

FIG. 7 is a cross sectional view of the ratchet wrench of FIG. 6 after assembly.

FIG. 8 is a perspective view of a ratchet wrench of a third embodiment according to the present invention.

FIG. 9 is a perspective view of a ratchet wrench of a fourth embodiment according to the present invention.

FIG. 10 is an exploded, perspective view of a conventional ratchet wrench.

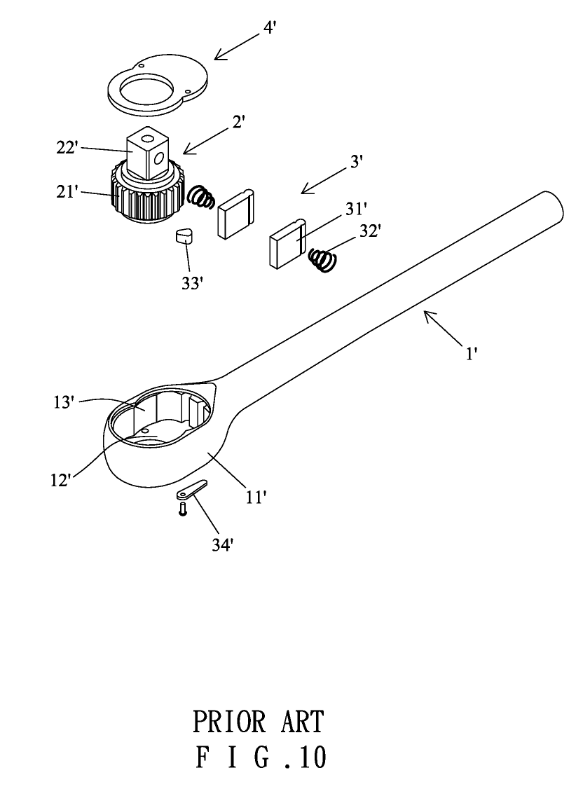

### DETAILED DESCRIPTION OF THE INVENTION

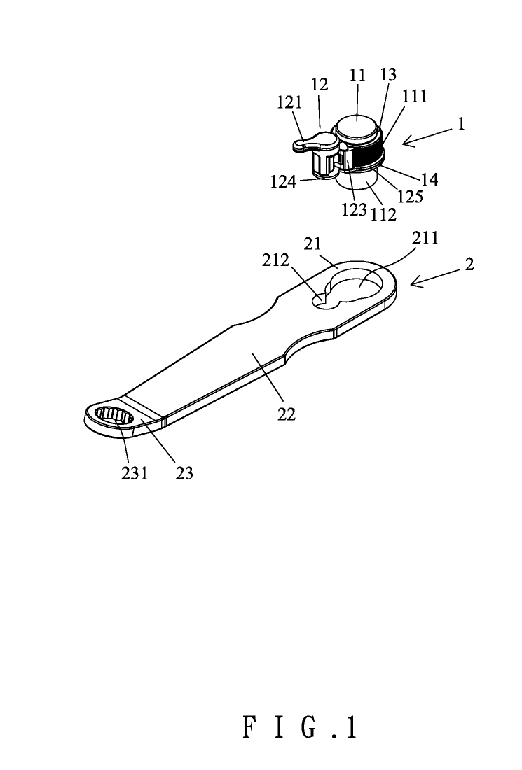

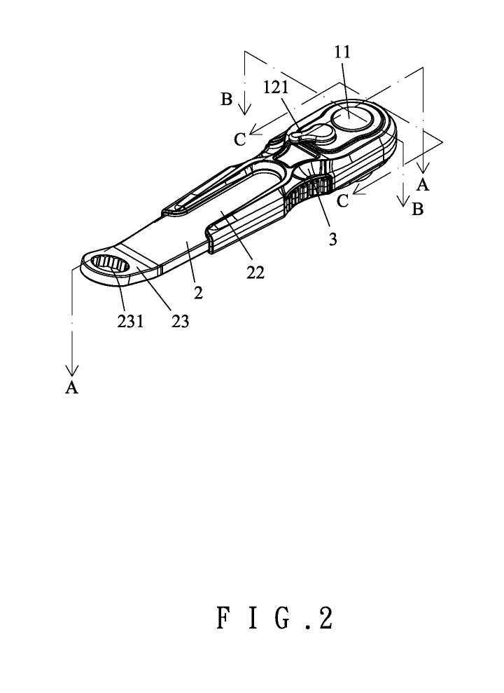

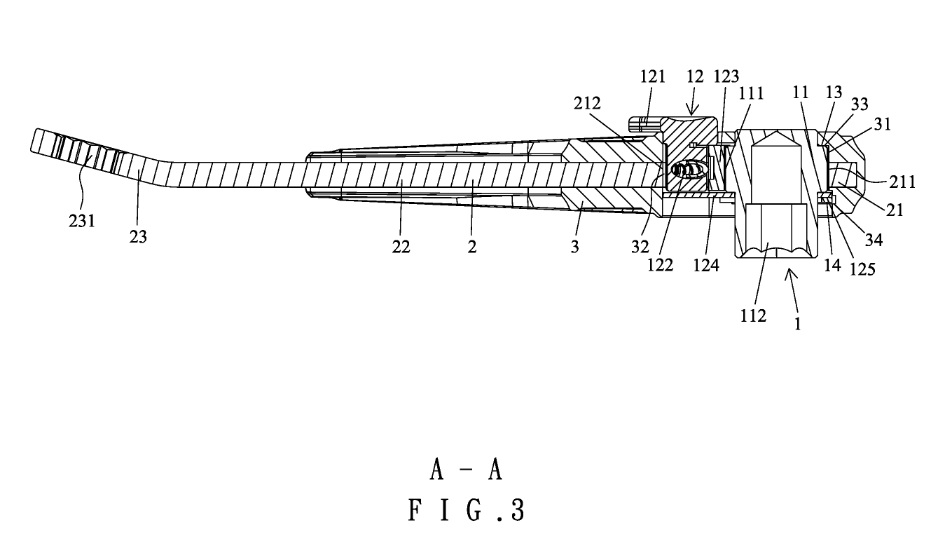

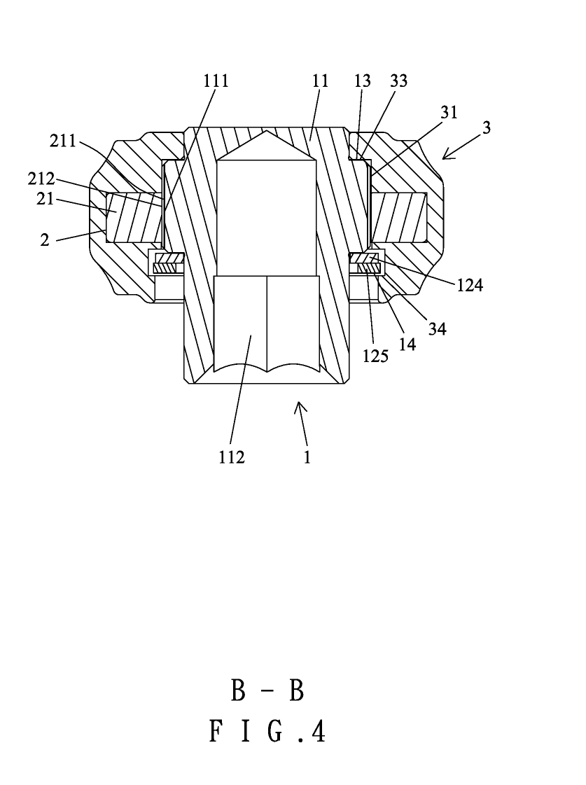

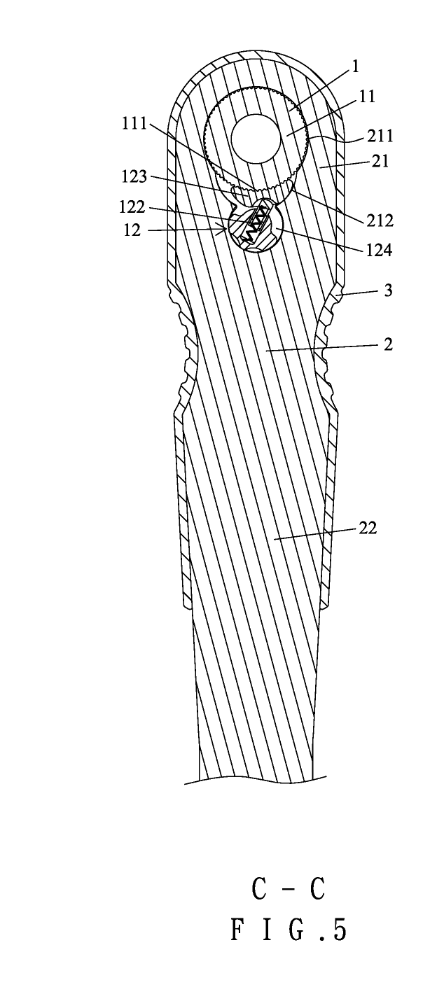

With reference to FIGS. 1-5, a ratchet wrench of a first embodiment according to the present invention includes a ratchet wheel device 1, a plate 2, and a stopper 3. The ratchet wheel device 1 includes a ratchet wheel 11 and a direction changing unit 12. The ratchet wheel 11 is made of metal and includes a ratchet teeth section 111 and a driving section 112. The direction changing unit 12 includes a switch 121, a spring 122, and a pawl 123. The pawl 123 is made of metal having a good strength and engages with the ratchet teeth section 111 of the ratchet wheel 11. The switch 121 is operatively coupled to the spring 122. The spring 122 has an end pressing against the pawl 123. The switch 121 can be operated to make the spring 122 press against the pawl 123 to thereby move the pawl 123 to different angular positions relative to the ratchet teeth section 111, controlling the ratchet wheel 11 to rotate relative to the plate 2 in only one direction. The switch 121 can be made of metal or non-metal material.

The ratchet wheel device 1 further includes a first abutment edge 13 and a second abutment edge 14 spaced from the first abutment edge 13 in an axial direction. In this embodiment, the direction changing unit 12 further includes a stop ring 124 and a retaining ring 125. The stop ring 124 abuts a side of the direction changing unit 12. The retaining ring 125 is coupled to the ratchet wheel 11 and abuts the stop ring 124. The retaining ring 125 includes a side forming the second abutment edge 14. The first abutment edge 13 is provided on a side of the ratchet wheel 11 opposite to the retaining ring 125.

The plate 2 is a flat block with a uniform thickness and made of metal. The plate 2 includes a first end having a coupling portion 21 and a second end having a handle portion 22. The coupling portion 21 is punched to form a first through-hole 211 through which the ratchet wheel device 1 extends. The first through-hole 211 includes an inner periphery 212 having a length in the axial direction smaller than a thickness of the ratchet teeth section 111 in the axial direction. The pawl 123 presses against the inner periphery 212 of the first through-hole 211. The handle portion 22 of the plate 2 includes an operative end 23. In this embodiment, the operative end 23 is punched to form a fastener driving hole 231 for driving a fastener, such as a bolt.

The stopper 3 is made of plastic material and is mounted around and envelops a peripheral edge of the coupling portion 21 of the plate 2. In this embodiment, the ratchet wheel device 1 is firstly mounted in the first through-hole 211 of the coupling portion 21 of the plate 2 and is then placed in a mold (not shown) to integrally form the stopper 3. The stopper 3 includes second and third through-holes 31 and 32 respectively located corresponding to the driving section 112 of the ratchet wheel device 1 and the switch 121 of the direction changing unit 12. The stopper 3 further includes a first stop edge 33 abutting the first abutment edge 13 and a second stop edge 34 abutting the second abutment edge 14, preventing the ratchet wheel device 1 from disengaging from the plate 2.

The coupling portion 21 of the plate 2 according to the present invention is without a sleeve having a depth for receiving the ratchet wheel device 1, such that the weight at the coupling portion 21 is reduced. Furthermore, the stopper 3 has a light weight, such that the ratchet wrench has a uniform weight distribution to provide convenient operation. Furthermore, the torque resulting from the driving section 112 driving a fastener can be transmitted through the ratchet teeth section 111 of the ratchet wheel 11 and the pawl 123 to the inner periphery 212 of the first through-hole 211 of the plate 2. The plate 2 made of metal provides a sufficient strength to withstand a larger torque. Thus, the stopper 3 according to the present invention is not the main torque-receiving element, such that the ratchet wrench provides better operational stability. Furthermore, the plate 2 is a flat block that can easily be punched to form the first through-hole 211 and the fastener driving hole 231, permitting easy manufacture. Furthermore, the stopper 3 can have any desired shape and can envelop the handle portion 22 to provide an aesthetic appearance and touching comfort.

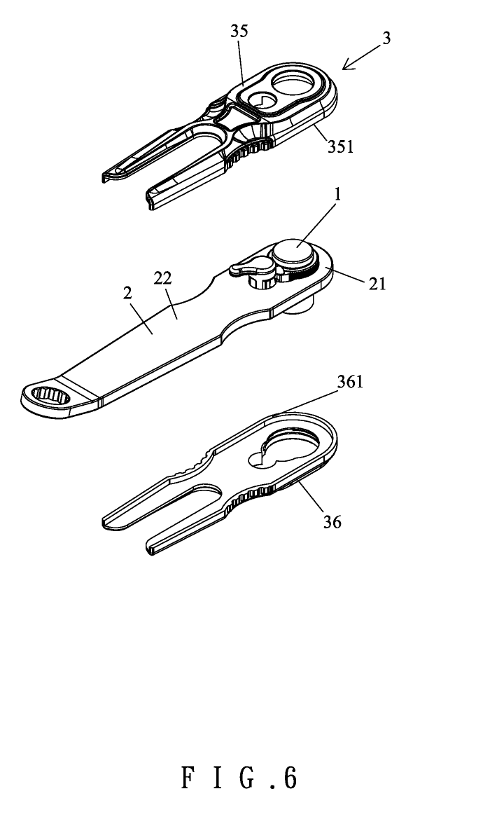

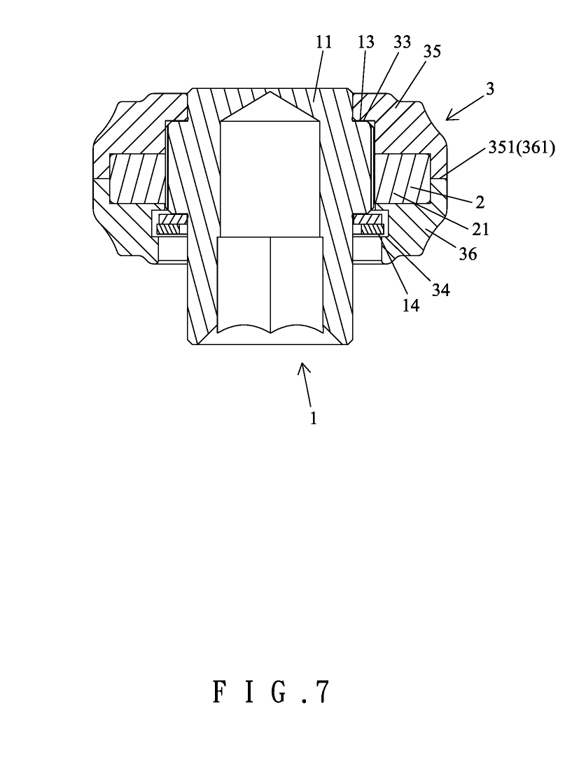

FIGS. 6 and 7 show a ratchet wrench of a second embodiment according to the present invention. The second embodiment is substantially the same as the first embodiment except that the stopper 3 is shaped to include a first cover 35 and a second cover 36. The first stop edge 33 is provided on the first cover 35, and the second stop edge 34 is provided on the second cover 36. The first and second covers 35 and 36 envelop the coupling portion 21 and the handle portion 22 of the plate 2. A peripheral edge of the first cover 35 is coupled with a peripheral edge of the second cover 36 by high frequency welding or other suitable provision.

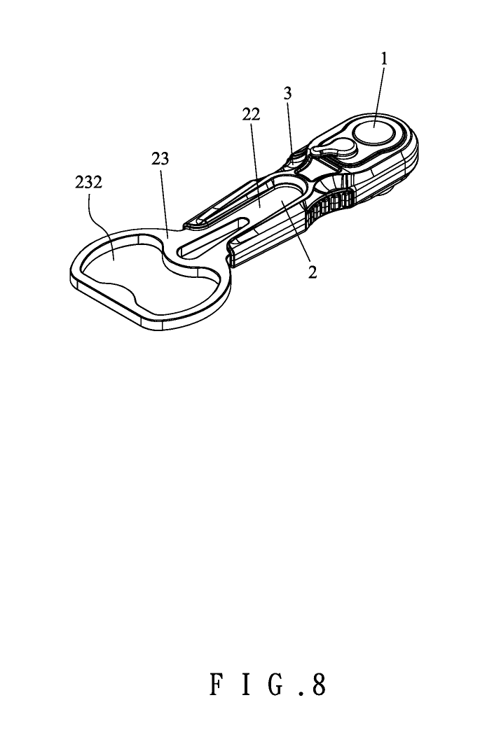

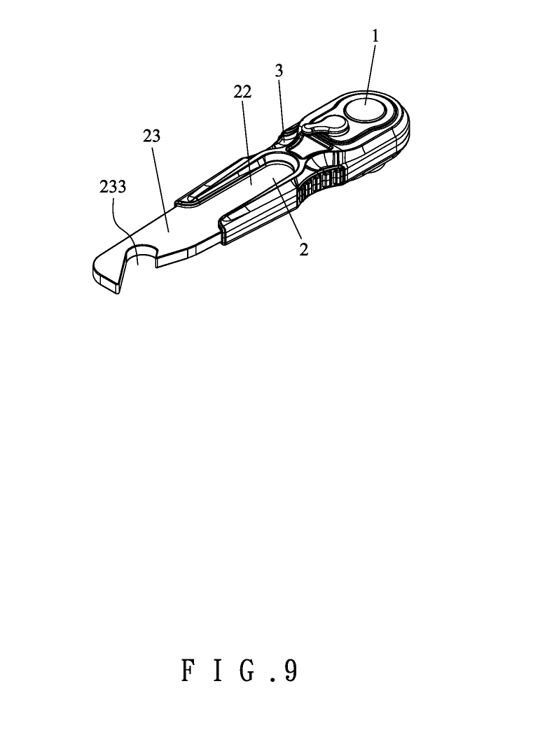

FIGS. 8 and 9 show ratchet wrenches of third and fourth embodiments according to the present invention. The third embodiment is substantially the same as the first embodiment except that the operative end 23 is punched to form a bottle opener 232. The fourth embodiment is substantially the same as the first embodiment except that the operative end 23 is punched to form a can opener 233. Nevertheless, other shapes of the operative end 23 are still possible according to needs.

In view of the foregoing, the ratchet wrench according to the present invention has a reduced, uniform weight, is easy to manufacture, and has better applications and a sense of quality. Furthermore, the ratchet wheel 11 and the direction change unit 12 of the ratchet wheel device 1 can be of other structures and should not be restricted to the structures shown.

Although specific embodiments have been illustrated and described, numerous modifications and variations are still possible without departing from the scope of the invention. The scope of the invention is limited by the accompanying claims.

1. A ratchet wrench comprising:
a ratchet wheel device including a ratchet wheel and a direction changing unit, with the ratchet wheel made of metal and including a ratchet teeth section and a driving section, with the direction changing unit including a pawl made of metal and engaged with the ratchet teeth section of the ratchet wheel, and with the direction changing unit further including a switch operable to control movement of the pawl to thereby permit the ratchet wheel to rotate in a single direction;
a plate made of metal and including a first end having a coupling portion, with the ratchet wheel device coupled to the coupling portion, with the plate further including a second end having a handle portion, with the coupling portion including a first through-hole through which the ratchet wheel device extends, with the first through-hole including an inner periphery, with the pawl pressing against the inner periphery of the first through-hole, and with the inner periphery of the first through-hole having a length in an axial direction smaller than a thickness of the ratchet teeth section in the axial direction; and
a stopper made of plastic material and mounted around a peripheral edge of the coupling portion of the plate, with the stopper including second and third through-holes respectively located corresponding to the driving section of the ratchet wheel device and the switch of the direction changing unit, and with the stopper preventing the ratchet wheel device from disengaging from the plate while permitting rotation of the ratchet wheel relative to the plate.

2. The ratchet wrench as claimed in claim 1, with the ratchet wheel device further including a first abutment edge and a second abutment edge spaced from the first abutment edge in the axial direction, and with the stopper further including a first stop edge abutting the first abutment edge and a second stop edge abutting the second abutment edge, preventing the ratchet wheel device from disengaging from the plate.

3. The ratchet wrench as claimed in claim 1, wherein after the ratchet wheel device is mounted to the coupling portion of the plate, the stopper is formed on the coupling portion of the plate by injection molding and envelops and engages with the coupling portion of the plate.

4. The ratchet wrench as claimed in claim 2, with the stopper including first and second covers, with the first stop edge provided on the first cover, with the second stop edge provided on the second cover, with the first cover and the second cover enveloping the coupling portion of the plate, with each of the first and second covers having a peripheral edge, and with the peripheral edge of the first cover coupled with the peripheral edge of the second cover.

5. The ratchet wrench as claimed in claim 1, wherein the stopper envelops the handle portion of the plate.

6. The ratchet wrench as claimed in claim 1, wherein the plate has a uniform thickness.

7. The ratchet wrench as claimed in claim 1, wherein the handle portion of the plate includes an operative end.

8. The ratchet wrench as claimed in claim 7, wherein the operative end is a fastener driving hole, a bottle opener, or a can opener.

9. The ratchet wrench as claimed in claim 1, with the direction changing unit of the ratchet wheel device further including a spring, with the switch operatively coupled to the spring, with the spring having an end pressing against the pawl, with the switch operable to make the spring press against the pawl to thereby move the pawl to different angular positions relative to the ratchet teeth section, controlling the ratchet wheel to rotate relative to the plate in only one direction.

10. The ratchet wrench as claimed in claim 9, with the direction changing unit further including a stop ring and a retaining ring, with the stop ring abutting a side of the direction changing unit, with the retaining ring coupled to the ratchet wheel and abutting the stop ring, with the retaining ring including a side forming the second abutment edge, and with the first abutment edge provided on a side of the ratchet wheel opposite to the retaining ring.
